(19) United States
(12) Patent Application Publication
(10) Pub. No.: US 2005/0240934 A1
(43) Pub. Date: Oct. 27, 2005

(54) Task management based on system utilization

(75) Inventors: Brian Patterson, Boise, ID (US); Charles Fuqua, Boise, ID (US); Guillermo Navarro, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 10/830,204

(22) Filed: Apr. 21, 2004

(51) Int. Cl. G06F 9/46

(52) U.S. Cl. 718/105

(57) ABSTRACT

A method of managing task execution comprises measuring a parameter indicative of workload and assigning priority of tasks executable on the system based on the measured parameter.

### BACKGROUND OF THE INVENTION

A continuing increase in processor performance that has substantially out-gained the increase in input/output (I/O) rates has given rise to an I/O bottleneck is addressed, at least partially, by improvements in I/O bandwidth in data storage. Various types of storage architectures have been designed to improve I/O performance. One example is Redundant Arrays of Independent Disks (RAID) technology that is designed to improve I/O bandwidth by distributing data through multiple disks so that multiple I/O requests can be served in parallel, thereby improving data transfer rate.

I/O devices are typically slow relative to the receipt of data by a storage array. Therefore improvement in I/O efficiency is useful to reduce service time. Disk I/O tasks can be queued to manage process flow to the storage elements. Strategies that assist task scheduling may also be valuable for increasing I/O performance.

### SUMMARY

In accordance with an embodiment of an illustrative system, a method of managing task execution comprises measuring a parameter indicative of workload and assigning priority of tasks executable on the system based on the measured parameter.

### BRIEF DESCRIPTION OF THE DRAWINGS

Embodiments of the invention relating to both structure and method of operation, may best be understood by referring to the following description and accompanying drawings.

FIG. 1 is a highly schematic flow chart that depicts an embodiment of a method for managing task execution in a storage array.

FIG. 2 is a flow chart illustrating an embodiment of a task management technique combining a utilization measurement and a queuing scheme.

FIG. 3 is a schematic block diagram illustrating an embodiment of an array controller that manages task execution based on system utilization in a storage array.

FIG. 4 is a schematic process model depicts an embodiment of a process model for task management in an array controller that manages task execution based on system utilization.

### DETAILED DESCRIPTION

Storage arrays, for example Redundant Arrays of Independent Disks (RAID) are storage devices that are intended to supply storage with better performance and reliability than individual disks. Real-time systems, such as storage arrays, can use a controller that processes tasks or processes based on a priority scheme. Some tasks are assigned relatively higher priorities, while other tasks are assigned lower priorities. For example, a priority scheme that executes within an array controller can simply include two queues, a high priority queue and a low priority queue. The array controller operates the low priority queue only when the high priority queue is empty.

Alternative schemes, such as more complex queuing schemes can be implemented. In one example, a queuing system may include multiple queues with each queue representing a different priority and each of the queues having a unique starvation-avoidance mechanism.

One difficulty with the simple and complex queuing solutions is a failure to address priority of task execution based on the state of the system in which the queues exist. More particularly, in a particular system under most circumstances or conditions, completion of a particular task may have a very low priority, but if the system is in some exceptional state, then execution of that particular task may become the most important system operation for immediate execution. Traditional priority queuing schemes do not account for system state, so that the task can remain at low priority status.

What is desired is a system or operating technique that accounts for varying system conditions and enables task prioritization based on system state, such as system utilization or workload.

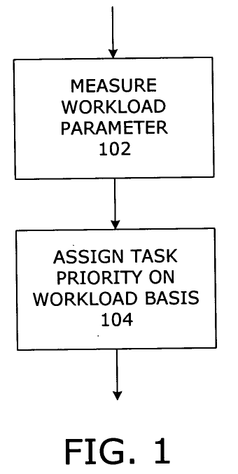

Referring to FIG. 1, a highly schematic flow chart depicts an embodiment of a method for managing task execution 100 in a storage array. The method 100 includes the actions of measuring 102 a parameter indicative of storage array workload, and assigning 104 priority of tasks executable on the storage array based on the measured parameter.

Storage disk array performance is at least partly influenced by current array workload. An array that is under a severe workload can be considered to function in a different state than an array under a small workload. Similarly, the arrays under severe and small workloads are in different states than an idle array. In the disclosed system and operating method, workload, which may also be termed utilization, is defined as the amount of work done by an array that other processes that are selected for low priority, for example background processes, cannot pre-empt or block. The instantaneous storage array workload level at least partly defines state of the storage array. Therefore accurate measurement of workload or utilization is useful for appropriate assessment of array state. In various configurations and conditions, workload, and equivalently utilization, can be defined to ensure that measurements accurately reflect the real array state. For example, for an array with a severe workload, then measurements are to reflect the severity of the workload, regardless of the applied utilization definition. Similarly, if the array is idle, and thus the workload is zero, then measurements are to accurately indicate that the array is idle.

One example of a suitable utilization or workload measurement is a count of the number of host input/output operations per unit time. Another example is a measurement of interface bandwidth as a proportion of bandwidth capacity.

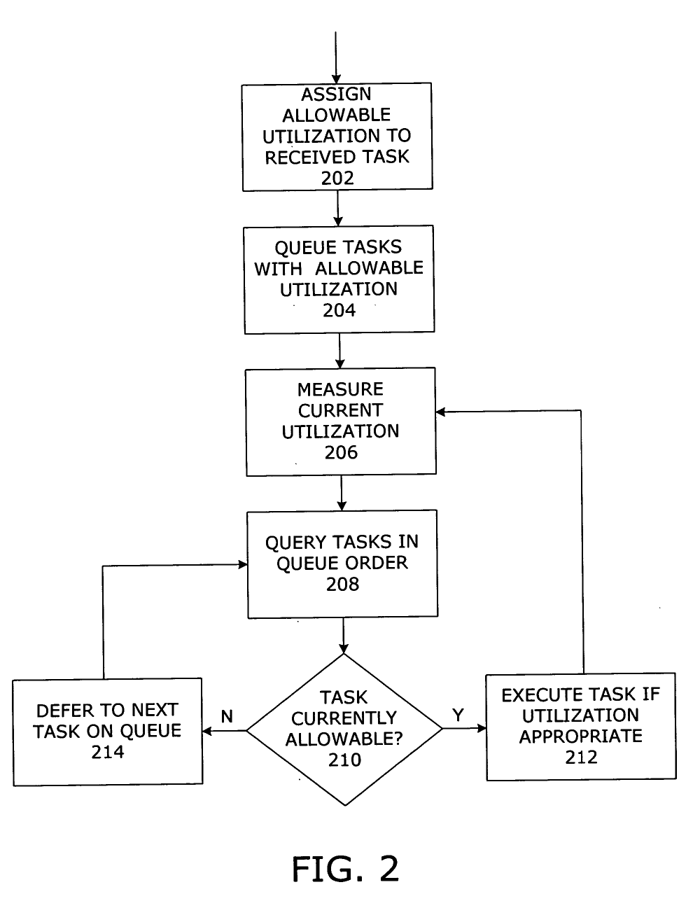

For any suitable utilization measurement, various embodiments of a task management technique use a system utilization measurement and associated parameter in combination with a queuing scheme to allocated task processes to a storage array. For example, referring to FIG. 2, a flow chart illustrates an embodiment of a task management technique 200 combining a utilization measurement and a queuing scheme. In a sequence of actions that typically repeats over time as tasks are received for handling, a received task can be assigned 202 a maximum allowable utilization value at which the task is authorized to execute. A queue of such tasks is maintained 204 with the individual tasks having the assigned maximum allowable utilization values. A current utilization value is measured 206, for example periodically or when task execution is to be allocated. The tasks on the queue are queried 208 in the queue order. A queried task having an assigned maximum allowable utilization value 210 higher than the current utilization value is executed 212. Otherwise, for a queried task that has an assigned maximum allowable utilization value lesser than the current utilization value execution is deferred 214 in favor of the next task on the queue, if any additional task is on the queue.

In some embodiments, a task management system can maintain multiple task queues including a task queue that bases execution on assigned and measured utilization, and at least one task queue with a priority that differs from the utilization based queue. For example, a high priority task queue can be maintained for queuing and executing, in the queue order, tasks assigned a high priority. The utilization task queue can simultaneously be maintained for queuing tasks and executing the tasks when the high priority queue is empty in an order based in part on the order of queuing and in part on assigned allowable utilization value of a task and a measured current utilization value of the storage array.

In some embodiments, a data structure associated with a utilization task queue can be maintained that is indicative of allowable utilization of all tasks on the queue. Tasks can be executed or execution deferred of all tasks on the utilization task queue based on the data structure and a measurement of current utilization. For example, the highest allowable utilization of any task process currently on the queue can be stored in a specific memory location. If the current utilization value is greater than the stored value, then no queued task is currently allowed to execute since no process on the queue has a sufficiently high utilization to execute. Therefore scanning of the utilization queue is superfluous and can be eliminated. Similarly, if the current utilization is below the stored value, then scanning the utilization queue is sure to find a process enabled to execute.

In other embodiments, optimizations may be implemented to reduce scan time to detect a process enabled to execute when the system is in a condition of a particular utilization. These optimizations maintain first-in, first-out ordering of process tasks that are enabled to execute. The optimizations facilitate use of the utilization queue. One example of such optimizations is the usage of a binary search through the queue rather than the linear search typical used to step through a queue.

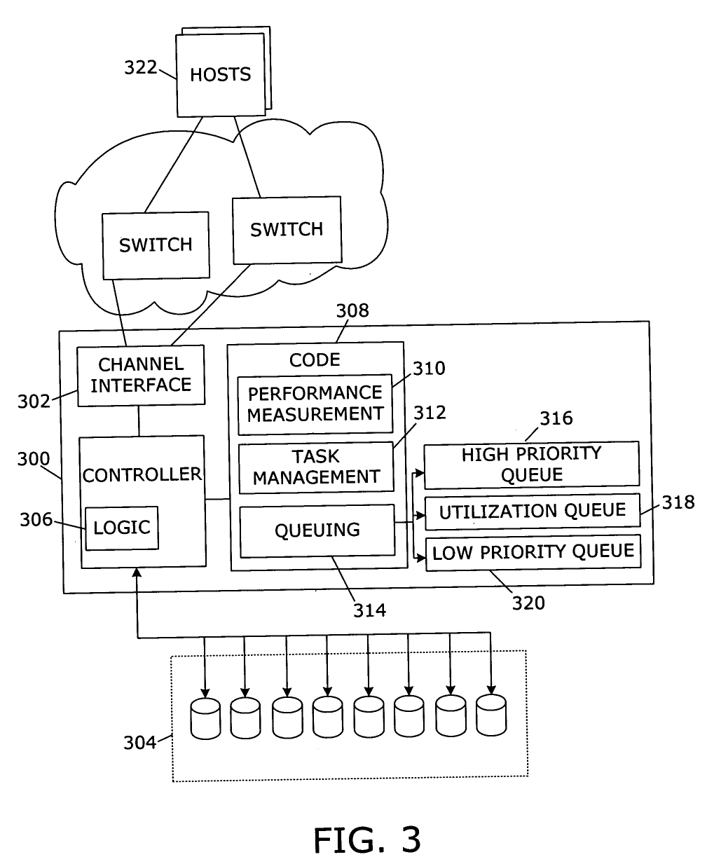

Referring to FIG. 3, a schematic block diagram illustrates an embodiment of an array controller 300 that manages task execution based on system utilization in a storage array. The array controller 300 includes an interface 302 capable of coupling to a storage array 304, and control logic 306. A code 308 executable on the control logic 306 includes a performance measurement utility 310 that measures a parameter indicative of storage array workload and a task management utility 312. The task management utility 312 assigns priority of tasks executable on the storage array based on the measured parameter.

The storage array 304 is typically a set of disk drives. The array controller 300 also generally includes a cache connected to a channel interface 302 connected to a host 322. The code 308 is commonly in the form of microcode with functionality to manage resources within the array including the channel interface 302 or directors, cache, disk adapters, and the disks. A large cache may be useful to improve performance for a system with a microcode that managing concurrent accesses, prefetching, destaging of data and the like.

In various embodiments, the performance measurement utility 310 can measures a performance criterion such as number of host input/output operations per unit time, interface bandwidth as a proportion of bandwidth capacity, disk busy, disk transfers per second, kbyte throughput per second, number of input/output operations per time interval, input/output wait percentage, and the like. Some embodiments may include a file monitor that monitors performance of the file system and reports I/O activity related to particular logical files, virtual memory segments, logical volumes, and physical volumes. File monitor information may be used to determine workload. Similarly, a workload analyzer may be included that tracks historical information relating to performance for the various storage elements within the array and reports values selected from among throughput of the channel interface 302, cache hits for various I/O types, read/write ratio, I/O workload of particular logical volumes, and the like.

In some embodiments, the code 308 can further include a queuing utility 314 that maintains a task queue and processes the tasks based at least in part on a current measurement of storage array workload.

In a particular configuration, the queuing utility 314 can function in combination with the task management utility 312 to maintain a queue of tasks with each task assigned a threshold utilization value. The performance measurement utility 310 periodically measures current utilization. The task management utility 312 executes tasks on the queue in the queue order so long as the current utilization meets the task threshold utilization.

In some embodiments, the queuing utility 314 can maintains a data structure associated with a utilization task queue that is indicative of allowable utilization of all tasks on the queue. On the basis of information in the data structure, the task management utility 312 executes or defers execution of all tasks on the utilization task queue based on the data structure and a measurement of current utilization.

In a specific example, the storage array 304 is controlled by the array controller 300 that processes tasks based at least partly on the current utilization measurement detected in the array 304. In a particular instantiation of a storage system, the task process queue on an array is issued a task for execution and a maximum allowable utilization is assigned at which the task is enabled to execute. Each time the queue is queried, the current utilization is measured by the performance measurement utility 310. If the current utilization is lower than the allowed utilization of the task at the head of the queue, then that task is enabled to run. If the current utilization is higher than the task's allowed utilization, then the task is skipped and the allowed utilization of the next task on the queue is tested. Analysis of tasks on the queue continues until a task is found that has an allowed utilization higher than the current measured utilization or until the queue is exhausted. If the end of the queue is scanned without finding a task enabled for execution, the current utilization is again measured and the process is repeated from the start of the queue. The illustrative technique first ensures that only those tasks enabled for execution on the basis of current measured utilization level are actually executed. The technique secondly ensures that under any measured utilization level, all processes that are enabled to be executed at the current measured level are actually executed in the queued order, generally first-in, first-out order. The second criterion or condition ensures that, so long as a task process has an allowable utilization level greater than the current measured utilization level, process or task starvation does not occur. For example, the task eventually does execute so long as the measured utilization remains acceptable.

In the illustrative configuration, most effectively the highest priority tasks or processes are set with the highest allowable utilization and the lowest priority tasks or processes are set with the lowest allowable utilization. Accordingly, as the measured utilization level increases, the only tasks that are enabled to execute are the highest priority tasks, and the high priority processes are executed in the order of placement on the queue. As the measured utilization level decreases, the older lower priority processes are favored.

Some systems may include a queuing utility 314 that maintains a multiple task queues including a task queue that bases execution on assigned and measured utilization, and at least one task queue with a priority that differs from the utilization based queue. In a particular example, a queuing utility 314 can be configured that maintains a high priority task queue 316 for queuing and executing, in the queue order, tasks assigned a high priority. The queuing utility 314 can also maintain a utilization task queue 318 that queues tasks and executing tasks, when the high priority queue is empty. Tasks on the utilization task queue 318 are executed in an order based in part on the order of queuing and in part on the assigned allowable utilization value of the tasks, in combination with the measured current utilization value of the storage array.

An array controller 300 can be programmed or configured to ensure that highest priority processes or tasks always take precedence over lower priority tasks by implementing the utilization task queue 318 in combination with other queues. For example, the queuing utility 314 can support a system with the high priority task queue 316, the utilization queue 318, and a low priority queue 320. In a particular example, the high priority task queue 316 can be processed first so that all tasks on the high priority queue 316 are processed before tasks on any other queue are handled. When the high priority task queue 316 is empty, the utilization queue 318 is processed so that tasks on the utilization queue 318 execute that are enabled on the basis of the assigned and measured current workload conditions. Tasks in the low priority queue 320 execute, generally on a first-in, first-out basis, when no tasks in the high priority queue 316 and the utilization queue 318 are available for execution. In the case of the utilization queue 318, no tasks are available for execution when the queue is empty or when any remaining task on the utilization queue 318 has a lower allowable utilization than the current utilization measurement value. Alternatively, the low priority queue 320 can be eliminated and any tasks to be executed at low priority can be assigned to the utilization queue 318 with a low allowable utilization threshold.

The illustrative array controller 300 can be any suitable type of array controller including arrays arranged as a Redundant Array of Independent Disks (RAID), for example in a structure selected from among RAID0, RAID1, RAID2, RAID3, RAID4, RAID5, RAID6, RAID7, RAID10. Similarly, the arrays can be arranged as Just A Bunch of Disks (JBODs), or other arrangements. The illustrative techniques can also be implemented on other types of electronic systems such as computers, communication systems, and the like.

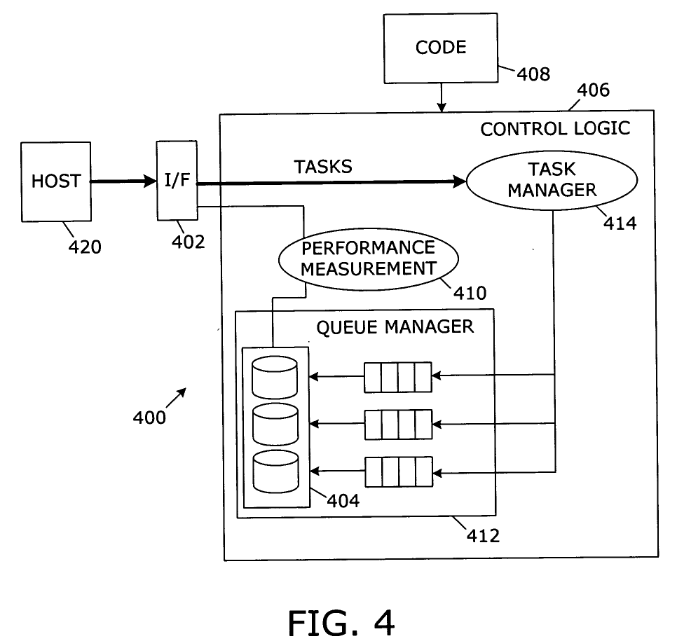

Referring to FIG. 4, a schematic process model depicts an embodiment of a process model for task management in an array controller 400 that manages task execution based on system utilization. One or more hosts computers 420 issue I/O tasks or processes at various times and rates to the array controller 400 for execution on a storage array 404. Different priorities can be assigned to the various tasks or processes. The storage array 404 is subject to varying workloads.

The array controller 400 includes an interface 402 capable of coupling to a storage array 404, control logic 406, and code 408 executable on the control logic 406. The code 408 includes a performance measurement utility 410, a queue manager 412, and a task management utility 414. The performance measurement utility 410 measures a parameter indicative of storage array workload. The queue manager 412 maintains a task queue of tasks assigned a workload threshold value. The task management utility 414 executes tasks acting on the storage array with a priority based on the storage array workload parameter and order on the task queue.

The queue manager 412 maintains a process queue for storage arrays, for example RAID storage arrays, that activates execution of a particular task based on the current measured system utilization and, for any process on the queue that meets the current utilization specification, a first-in, first-out ordering scheme. The technique can be implemented for any suitable definition of utilization or workload so long as the defined parameter is representative of the actual amount of work currently performed on the storage array that any particular task on the queue is specified not to pre-empt or block. The technique can be implemented in various types of storage arrays, such as various RAID or JBOD systems, and can also be implemented in electronic systems other than storage systems, such as computers, data processors, communication systems, and the like.

The various functions, processes, methods, and operations performed or executed by the system can be implemented as programs that are executable on various types of processors, controllers, central processing units, microprocessors, digital signal processors, state machines, programmable logic arrays, and the like. The programs can be stored on any computer-readable medium for use by or in connection with any computer-related system or method. A computer-readable medium is an electronic, magnetic, optical, or other physical device or means that can contain or store a computer program for use by or in connection with a computer-related system, method, process, or procedure. Programs can be embodied in a computer-readable medium for use by or in connection with an instruction execution system, device, component, element, or apparatus, such as a system based on a computer or processor, or other system that can fetch instructions from an instruction memory or storage of any appropriate type. A computer-readable medium can be any structure, device, component, product, or other means that can store, communicate, propagate, or transport the program for use by or in connection with the instruction execution system, apparatus, or device.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims. The illustrative usage and optimization examples described herein are not intended to limit application of the claimed actions and elements. For example, the illustrative task management techniques may be implemented in any types of storage systems that are appropriate for such techniques, including any appropriate media. Similarly, the illustrative techniques may be implemented in any appropriate storage system architecture. The task management techniques may further be implemented in devices other than storage systems including computer systems, data processors, application-specific controllers, communication systems, and the like.

1. A method of managing task execution in a storage system comprising:
measuring a parameter indicative of storage system workload; and
assigning priority of tasks executable on the system based on the measured parameter.

2. The method according to claim 1 further comprising:
counting a number of host input/output operations per unit time as the parameter indicative of workload.

3. The method according to claim 1 further comprising:
measuring interface bandwidth as a proportion of bandwidth capacity as the parameter indicative of workload.

4. The method according to claim 1 further comprising:
assigning to a task a maximum allowable utilization value at which the task is authorized to execute;
maintaining a queue of tasks, the individual tasks having the assigned maximum allowable utilization values;
measuring a current utilization value;
querying the tasks on the queue in the queue order;
executing a queried task that has an assigned maximum allowable utilization value higher than the current utilization value; and
deferring to a next task on the queue, if any, for a queried task that has an assigned maximum allowable utilization value lesser than the current utilization value.

5. The method according to claim 1 further comprising:
maintaining a plurality of task queues including a task queue that bases execution on assigned and measured utilization, and at least one task queue with a priority that differs from the utilization based queue.

6. The method according to claim 1 further comprising:
maintaining a high priority task queue for queuing and executing, in the queue order, tasks assigned a high priority; and
maintaining a utilization task queue for queuing and executing tasks, when the high priority queue is empty, in an order based in part on the order of queuing and in part on assigned allowable utilization value of a task and a measured current utilization value.

7. The method according to claim 1 further comprising:
maintaining a data structure associated with a utilization task queue indicative of allowable utilization of all tasks on the queue; and
executing or deferring execution of all tasks on the utilization task queue based on the data structure and a measurement of current utilization.

8. An array controller comprising:
an interface capable of coupling to a storage array;
a control logic; and
a code executable on the control logic comprising:
a performance measurement utility that measures a parameter indicative of storage array workload; and
a task management utility that assigns priority of tasks executable on the storage array based on the measured parameter.

9. The array controller according to claim 8 wherein:
the executable code further comprises a queuing utility that maintains a task queue and processes the tasks based at least in part on a current measurement of storage array workload.

10. The array controller according to claim 9 wherein the task management utility operates in combination with the queuing utility and the performance measurement utility to maintain a queue of tasks with each task assigned a threshold utilization, periodically measure current utilization, and execute tasks on the queue in the queue order so long as the current utilization meets the task threshold utilization.

11. The array controller according to claim 8 wherein the performance measurement utility measures a performance criterion selected from among a group consisting of number of host input/output operations per unit time, interface bandwidth as a proportion of bandwidth capacity, disk busy, disk transfers per second, kbyte throughput per second, number of input/output operations per time interval, and input/output wait percentage.

12. The array controller according to claim 8 wherein:
the executable code further comprises a queuing utility that maintains a plurality of task queues including a task queue that bases execution on assigned and measured utilization, and at least one task queue with a priority that differs from the utilization based queue.

13. The array controller according to claim 8 wherein:
the executable code further comprises a queuing utility that maintains a high priority task queue for queuing and executing, in the queue order, tasks assigned a high priority, and that maintains a utilization task queue for queuing and executing tasks, when the high priority queue is empty, in an order based in part on the order of queuing and in part on assigned allowable utilization value of a task and a measured current utilization value of the storage array.

14. The array controller according to claim 8 wherein:
the executable code further comprises a queuing utility that maintains a data structure associated with a utilization task queue indicative of allowable utilization of all tasks on the queue, and that executes or defers execution of all tasks on the utilization task queue based on the data structure and a measurement of current utilization.

15. The array controller according to claim 8 wherein:
the storage array is a Redundant Array of Independent Disks (RAID) array in a structure selected from among RAID0, RAID1, RAID2, RAID3, RAID4, RAID5, RAID6, RAID7, and RAID10.

16. An array controller comprising:.
an interface capable of coupling to a storage array;
a control logic; and
a code executable on the control logic comprising:
a performance measurement utility that measures a parameter indicative of storage array workload;
a queue manager that maintains a task queue of tasks assigned a workload threshold value; and
a task management utility that executes tasks acting on the storage array with a priority based on the storage array workload parameter and order on the task queue.

17. The array controller according to claim 16 wherein the queue manager maintains a high priority task queue for queuing and executing, in the queue order, tasks assigned a high priority, and that maintains a utilization task queue for queuing and executing tasks, when the high priority queue is empty, in an order based in part on the order of queuing and in part on assigned allowable utilization value of a task and a measured current utilization value of the storage array.

18. The array controller according to claim 16 wherein the performance measurement utility measures a performance criterion selected from among a group consisting of number of host input/output operations per unit time, interface bandwidth as a proportion of bandwidth capacity, disk busy, disk transfers per second, kbyte throughput per second, number of input/output operations per time interval, and input/output wait percentage.

19. An article of manufacture comprising:
a controller usable medium having a computable readable program code embodied therein for managing task execution in a storage array comprising, the computable readable program code further comprising:
a code capable of causing the controller to measure a parameter indicative of storage array workload;
a code capable of causing the controller to assign priority of tasks executable on the storage array based on the measured parameter.

20. The article of manufacture according to claim 19 wherein the computable readable program code further comprises:
a code capable of causing the controller to maintain a queue of tasks with each task assigned a threshold utilization;
a code capable of causing the controller to periodically measure current utilization; and
a code capable of causing the controller to execute tasks on the queue in the queue order so long as the current utilization meets the task threshold utilization.
